(19) United States
(12) Patent Application Publication
(10) Pub. No.: US 2024/0286475 A1
(43) Pub. Date: Aug. 29, 2024

(54) REUSABLE PROTECTIVE PANELS FOR VEHICLES

(71) Applicants: Jean-Philippe Fontaine, Buford, GA (US); Laurent Fontaine, Buford, GA (US)

(72) Inventors: Jean-Philippe Fontaine, Buford, GA (US); Laurent Fontaine, Buford, GA (US)

(21) Appl. No.: 18/440,189

(22) Filed: Feb. 13, 2024

Related U.S. Application Data
(60) Provisional application No. 63/448,890, filed on Feb. 28, 2023.

(51) Int. Cl. B60J 11/06

(52) U.S. Cl. CPC B60J 11/06

(57) ABSTRACT

Disclosed is a reusable protective panel configured to adhere to an exterior surface of a vehicle, and to protect the exterior surface of the vehicle against scratches and dents. The reusable protective panel is flexible and can be shaped and dimensioned to fit on a particular exterior surface. An example reusable protective panel comprises a substrate layer that is a flexible material suitable for being printed on, an ink layer printed on the substrate layer, and a protective layer bonded to the ink layer. The protective layer is configured to protect the ink layer against scratches.

### CROSS-REFERENCE TO RELATED APPLICATION(S)

This application claims the benefit of U.S. Provisional Application Ser. No. 63/448,890, filed on Feb. 28, 2023, the entirety of which is incorporated herein by reference.

### TECHNICAL FIELD

This disclosure relates to reusable protective panels for vehicles.

### BACKGROUND

In the realm of automotive care and maintenance, preserving the aesthetic and structural integrity of a vehicle's exterior surfaces is desirable. Traditional methods for safeguarding these surfaces include the application of vinyl wraps or the magnetic attachment of protective panels. Despite these protective measures, off-road vehicles, such as four-wheel-drive and sports utility vehicles, are particularly susceptible to external damage. As these vehicles traverse rugged terrains and dense vegetation, their exteriors are prone to fine scratches that mar the surface, compromising both the vehicle's appearance and its protective barriers. These scratches not only detract from the vehicle's aesthetic appeal but also pose a risk for corrosion, thereby undermining the longevity and value of the vehicle. Furthermore, when vehicles are adorned with vinyl wraps or protective panels featuring graphics, these scratches can significantly damage the printed designs, affecting the visual presentation and potentially the protective qualities of the coverings.

Accordingly, needs exist for the reusable protective panels disclosed herein. It is to the provision of reusable protective panels configured to address these needs, and others, that the present invention is primarily directed.

### SUMMARY OF THE INVENTION

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Disclosed is a reusable protective panel configured to adhere to an exterior surface of a vehicle, and to protect the exterior surface of the vehicle against scratches and dents. The reusable protective panel is flexible and can be shaped and dimensioned to fit on a particular exterior surface.

An example reusable protective panel comprises a substrate layer that is a flexible material suitable for being printed on, an ink layer printed on the substrate layer, and a protective layer bonded to the ink layer. The protective layer is configured to protect the ink layer against scratches.

Another example reusable protective panel comprises a substrate layer that is a flexible vinyl film suitable for being printed on, an ink layer printed on the substrate layer, and a protective layer, bonded to the ink layer, that is an embossed flexible vinyl film. The protective layer is configured to protect the ink layer against scratches.

An example method for forming a reusable protective panel comprises the following steps: applying a pressure-sensitive adhesive to a first side of a substrate layer, which is a flexible vinyl film; printing an ink layer on a second side, positioned opposite the first side, of the substrate layer; and bonding a protective layer, which is an embossed flexible vinyl film, to the ink layer.

### BRIEF DESCRIPTION OF THE DRAWINGS

FIG. 1 is a cross-sectional view of a reusable protective panel consistent with the principles of the present disclosure.

FIGS. 2A-2C illustrate reusable protective panels on the exterior of a vehicle.

Like reference numerals refer to corresponding parts throughout the several views of the drawings.

### DETAILED DESCRIPTION

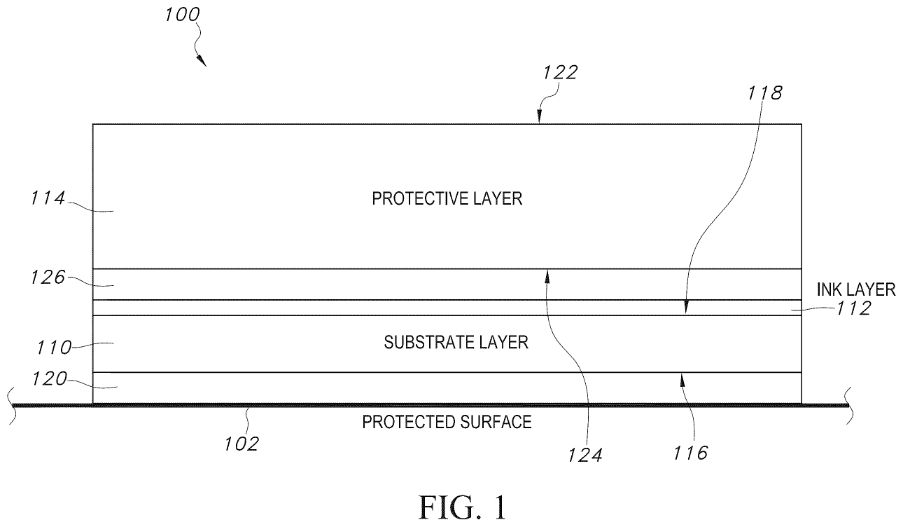

FIG. 1 illustrates a cross-sectional view of a reusable protective panel 100 adhered to a surface 102 to be protected, such as an exterior surface of a vehicle.

As shown, a reusable protective panel 100 comprises a substrate layer 110, an ink layer 112 printed on the substrate layer 110, and a protective layer 114 bonded to the ink layer 112. The reusable protective panel 100 is configured to be repeatedly applied to and removed from a surface 102, and to protect the surface 102 against scratches and dents. The reusable protective panel 100 is also configured to protect the ink layer 12 against scratches and dents.

The substrate layer 110 of a reusable protective panel 100 is a flexible vinyl film suitable for being printed on. In the preferred implementation, the flexible vinyl film is white and about 8 mil thick. However, the substrate layer 110 can be thicker than 8 mil. The substrate layer 110 defines a first substrate side 116 and an opposite second substrate side 118. The first substrate side 116 of the substrate layer 110 is coated with a pressure-sensitive adhesive 120 used to removably adhere the reusable protective panel 100 to a surface 102 to be protected. In the preferred implementation, the pressure-sensitive adhesive 120 is a layer of micro-sphere low tack adhesive that is approximately 2 mil thick. However, the layer of pressure-sensitive adhesive 120 may be thicker than 2 mil. The pressure-sensitive adhesive 120 allows a reusable protective panel 110 to be removed without the use of chemicals and does not leave behind a sticky residue.

In some implementations, a release liner is used to cover and protect the pressure-sensitive adhesive 120 when the reusable protective panel 100 is not in use (not shown).

The ink layer 112 of a reusable protective panel 100 is printed onto the second substrate side 118 of the substrate layer 110. In the preferred implementation, the ink layer 112 is formed with an ultraviolet (UV) curable ink (e.g., a latex UV curable ink). In other implementations, the ink layer 112 can be formed with a solvent ink or any other suitable type of ink. The example ink layer 112 is printed directly onto the substrate layer 110 by a printing machine (e.g., a large format latex printer). The ink layer 112 can be a solid color or form various indicia, which can include, for example, words, graphics, artistic designs, and the like.

The protective layer 114 of a reusable protective panel 100 is an embossed transparent flexible vinyl film that covers the ink layer 112 printed on the substrate layer 110. In the preferred implementation, the transparent flexible vinyl film is clear and about 21 mil thick. However, the protective layer 114 can be translucent and/or thicker than 21 mil. The embossed exterior of the protective layer 114 increases scratch resistance, as opposed to a smooth exterior. The protective layer 114 is clear so that the underlying ink layer 112 is visible. The thickness and material properties (e.g., hardness and resilience) of the protective layer 114 provide for a tough scratch resistant exterior surface that is also resistant to impacts. The protective layer 114 can define a first protective layer side 122 and an opposite second protective layer side 124. The first protective layer side 122 is embossed. The second protective layer side 124 is adhered to the ink layer 112. In the preferred implementation, the second protective layer side 124 is coated with a permanent adhesive 126 which bonds the protective layer 114 to the ink layer 112. In the preferred implementation, the permanent adhesive 126 is approximately 2 mil thick. However, the layer of permanent adhesive 126 may be thicker than 2 mil.

The protective layer 114 can be secured to the ink layer 112 using a hot rolling calendar press machine. The hot rolling calendar press machine uses pressure and heat to bond the permanent adhesive 126, and thereby the protective layer 114, to the ink layer 114 printed on the substrate layer 110. In this way, a reusable protective panel 110 is formed.

The reusable protective panel 100 disclosed herein has an, approximate, overall thickness of 33 mil. While it is disclosed that the substrate layer 110, protective layer 114, pressure-sensitive adhesive layer 120, and permanent adhesive layer 126 may each be thicker than the preferred implementations, testing has shown that a reusable protective panel 100 that is more than 41 mil thick is not ideal due to limited flexibility.

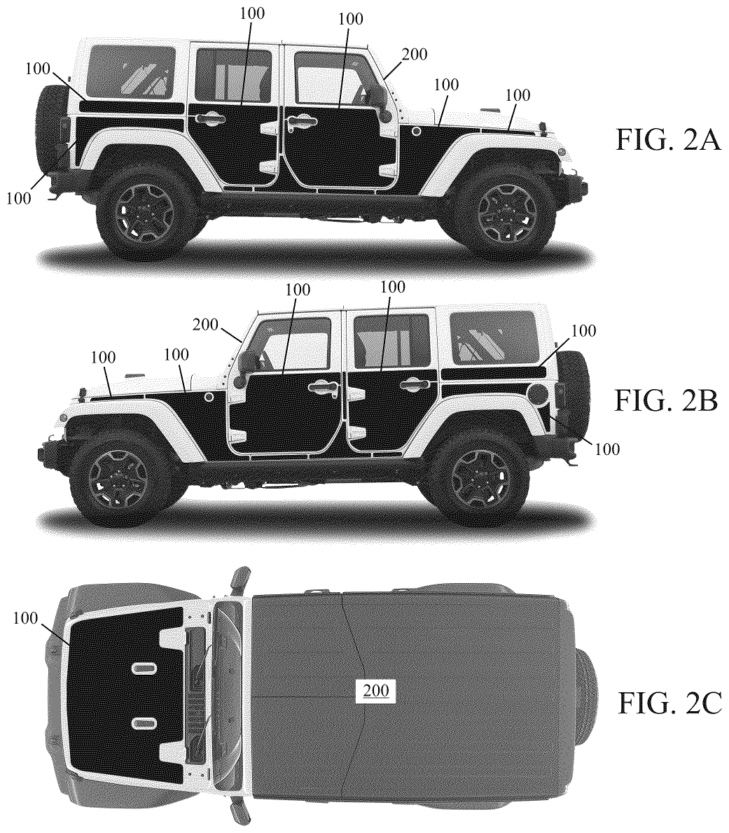

As shown in FIGS. 2A-2C, a reusable protective panel 100 is flexible and can be shaped and dimensioned to fit on a particular surface. For example, a reusable protective panel 100 to be used on the hood of a vehicle (e.g., a jeep 200) can be shaped and dimensioned to cover a particular make and model of the vehicle (see, e.g., FIG. 2C). A reusable protective panel 100 designed for a specific make and model of vehicle will substantially cover the surface to be protected. In some implementations, reusable protective panels 100 are die cut from larger sheets into desired shapes.

### USE AND OPERATION

The following steps may be used to adhere a reusable protective panel 100 to the exterior of a vehicle 200. Initially, clean the surface to be protected (e.g., the door) by removing all moisture and other residues. Then, if present, remove the release liner covering the pressure-sensitive adhesive 120. Next, align the reusable protective panel 100 with the corresponding vehicle panel and press the reusable protective panel 100 against the surface to be protected. The pressure-sensitive adhesive 120 on the underside of the reusable protective panel 100 will immediately adhere to the vehicle panel.

If required, a reusable protective panel 100 can be modified to fit a particular surface using a sharp knife or scissors.

The foregoing description of the invention is intended to be illustrative; it is not intended to be exhaustive or to limit the claims to the precise forms disclosed. Those skilled in the relevant art can appreciate that many modifications and variations are possible in light of the foregoing description and associated drawings.

Reference throughout this specification to an “embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. A reusable protective panel configured to adhere to an exterior surface of a vehicle, the reusable protective panel comprising:
a substrate layer that is a flexible material suitable for being printed on;
an ink layer printed on the substrate layer; and
a protective layer bonded to the ink layer;
wherein:
the protective layer is configured to protect the ink layer against scratches.

2. The reusable protective panel of claim 1, wherein the protective layer is an embossed flexible vinyl film.

3. The reusable protective panel of claim 2, wherein the protective layer is transparent.

4. The reusable protective panel of claim 2, wherein the protective layer is at least 21 mil thick.

5. The reusable protective panel of claim 1, wherein the substrate layer defines a first substrate side and an opposite second substrate side, the first substrate side is coated with a pressure-sensitive adhesive used to removably adhere the reusable protective panel to the exterior surface of the vehicle, the ink layer is printed on the second substrate side.

6. The reusable protective panel of claim 5, wherein the protective layer defines a first protective layer side and an opposite second protective layer side, the first protective layer side is embossed and the second protective layer side is coated with an adhesive which bonds the protective layer to the ink layer.

7. A reusable protective panel configured to adhere to an exterior surface of a vehicle, the reusable protective panel comprising:
a substrate layer that is a flexible vinyl film suitable for being printed on;
an ink layer printed on the substrate layer; and
a protective layer, bonded to the ink layer, that is an embossed flexible vinyl film;
wherein:
the protective layer is configured to protect the ink layer against scratches.

8. The reusable protective panel of claim 7, wherein the protective layer is at least 21 mil thick.

9. The reusable protective panel of claim 7, wherein the protective layer is transparent.

10. The reusable protective panel of claim 7, wherein the substrate layer defines a first substrate side and an opposite second substrate side, the first substrate side is coated with a pressure-sensitive adhesive used to removably adhere the reusable protective panel to the exterior surface of the vehicle, the ink layer is printed on the second substrate side.

11. The reusable protective panel of claim 10, wherein the protective layer defines a first protective layer side and an opposite second protective layer side, the first protective layer side is embossed and the second protective layer side is coated with an adhesive which bonds the protective layer to the ink layer.

12. A method for forming a reusable protective panel configured to adhere to an exterior surface of a vehicle, the method comprising:
applying a pressure-sensitive adhesive to a first side of a substrate layer that is a flexible vinyl film;
printing an ink layer on a second side, positioned opposite the first side, of the substrate layer; and
bonding a protective layer, that is an embossed flexible vinyl film, to the ink layer.

13. The method of claim 12, the method further comprising shaping and dimensioning the reusable protective panel to fit on the exterior surface of the vehicle.
